(19) United States
(12) Patent Application Publication
(10) Pub. No.: US 2026/0346136 A1
(43) Pub. Date: Nov. 5, 2026

(54) GENERIC VEHICLE PLATFORM COMPATIBLE INTERFACE FOR GAMING

(71) Applicant: AUMOVIO Systems, Inc., Auburn Hills, MI (US)

(72) Inventors: Jesse Aaron Hacker, West Bloomfield, MI (US); Brian Saloka, Harrison Township, MI (US); Peter Seydel, Troy, MI (US)

(73) Assignee: AUMOVIO Systems, Inc., Auburn Hills, MI (US)

(21) Appl. No.: 19/665,538

(22) Filed: May 1, 2026

Related U.S. Application Data
(60) Provisional application No. 63/798,692, filed on May 2, 2025.

(51) Int. Cl. A63F 13/355; A63F 13/73; A63F 13/79; A63F 13/803

(52) U.S. Cl. CPC A63F 13/355; A63F 13/73; A63F 13/79; A63F 13/803

(57) ABSTRACT

A first interface is configured to obtain first bus access information corresponding to a vehicle platform, and obtain signals placed onto the vehicle communications bus using the first bus access information. A data conversion hardware abstraction layer is configured to convert the signals obtained from the vehicle communications bus via the first interface into converted data having a simplified format. A second interface configured to receive the converted data from the data conversion hardware abstraction layer, interface with a software gaming application being executed by a software platform using second bus access information, and transmit the converted data to a software gaming application using the second bus access information. The converted data is utilized by the software gaming application to control a component or system of the vehicle, or be utilized by the software gaming application in a game.

### CROSS-REFERENCE TO RELATED APPLICATIONS

This application claims the benefit of U.S. Provisional Application No. 63/798,692, titled Generic Vehicle Platform Compatible Interface for Gaming, filed May. 2, 2025, which is incorporated herein by reference in its entirety.

### TECHNICAL FIELD

This disclosure relates to an interface to a vehicle platform and particularly to a vehicle platform independent interface which provides vehicle data for use in software development, gaming, and enables vehicle device control.

### BRIEF DESCRIPTION OF THE DRAWINGS

FIG. 1 depicts providing various vehicle data to gaming developers and access to vehicle device control by the developed game according to some embodiments.

FIG. 2 is a block diagram of an API which generally bridges a vehicle bus and vehicle device with a software developer platform according to some embodiments.

FIG. 3 is a schematic block diagram of the API of FIG. 2 according to some embodiments.

FIG. 4 is a diagram showing interactions between an API and a game according to some embodiments.

FIG. 5 is a diagram showing interactions between an API and a game according to some embodiments.

FIG. 6 is a flow diagram illustrating a data conversion hardware abstraction layer according to some embodiments.

FIG. 7 is a block diagram of a software platform according to some embodiments.

FIG. 8 is a flowchart of an approach according to some embodiments.

Like reference symbols in the various drawings indicate like elements. Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The present disclosure is generally directed to enabling in-vehicle experiences, such as gaming, to be created and used based on a universal, generic interface definition and hardware abstraction layer. The present disclosure avoids needing to customize to each vehicle’s unique platform-specific interface definition or having to adapt to different sensors, actuators and human machine interfaces (HMIs) for a particular vehicle.

As used herein, a software application refers to one or more computer programs, software modules, executable instructions, or combinations thereof that are configured to execute on one or more processing devices and perform one or more functions when executed by at least one processor. A software application may be implemented as compiled code, interpreted code, scripts, machine-learning models, or combinations thereof, and may be stored on one or more computer-readable media. The software application may operate locally on a computing device, remotely on a networked computing resource, or in a distributed manner across multiple computing systems.

In the context of the approaches provided herein, a software application is configured to communicate with an application programming interface (API) via an interface, to request information derived from vehicle sensors, to receive converted or abstracted vehicle data, and/or to transmit control instructions that cause actuation of one or more physical vehicle components to mention a few examples. Other examples are possible.

A software application may include, but is not limited to, logic for data processing, state management, user interaction, rule evaluation, scoring, decision making, visualization, audio generation, or control signaling. The term software application expressly includes applications developed using game engines, simulation frameworks, experience design tools, or other interactive software environments.

As used herein, a computer (or electronic) game is a type of software application that implements interactive logic governing game states, player actions, rules, objectives, and outcomes, and that responds dynamically to user input, system input, or environmental conditions. A computer game may include one or more gameplay mechanics such as scoring, turn-based interaction, real-time interaction, cooperative or competitive play, object identification, pattern recognition, progression systems, or challenge completion. A computer game may present visual, auditory, or haptic output to one or more users and may receive user input via physical controllers, touch interfaces, voice input, gesture input, or other human–machine interfaces.

In the disclosed embodiments, a computer game is configured to interact with an API to obtain information derived from physical vehicle sensors or digital twin data, including information representative of objects, conditions, or events occurring within or around a vehicle. The computer game may further transmit instructions through the API that indirectly or directly control physical vehicle components, subject to safety and authorization constraints.

A computer game may operate in real time or non-real time, may be executed using live sensor data or recorded data, and may incorporate conversational or multi-turn interaction with the API. The term computer game includes entertainment games, educational games, training games, simulation games, and experience-driven interactive applications.

As used herein, a computer game is a specific type of software application. Accordingly, references to a “software application” in the claims and description are intended to encompass computer games, unless the context explicitly indicates otherwise. Although the primary application disclosed herein is a gaming application, it will be appreciated that this dis closure is not limited to gaming applications.

In greater detail, the disclosed approaches relates to a generic, vehicle-platform-compatible application programming interface (API) that enables interactive software applications—particularly in-vehicle computer games and experiences—to operate across different vehicle architectures without requiring customization for vehicle-specific sensors, buses, or interfaces. One objective of the approaches provided herein is to decouple software development from the underlying vehicle hardware and platform complexity while preserving safety, security, and portability.

As used herein, a vehicle platform refers to a vehicle type or specific vehicle system of a specific vehicle type. A tool platform or software development platform means any hardware or software combination that is used to develop software applications such as computer games and/or execute these games (or other applications).

At the vehicle side, the API interfaces with a vehicle communications bus, which may be AUTOSAR-compliant or non-AUTOSAR, and listens for signals originating from a wide variety of vehicle sensors and subsystems. These sensors may include external perception sensors (such as radar and cameras), in-cabin monitoring sensors, steering and motion sensors, GPS or map data sources, and human–machine interfaces. Gateways translate raw sensor outputs into bus-compatible signals, which are then detected and subscribed to by the API.

In examples, the system includes a data conversion and hardware abstraction layer, which transforms platform-specific and sensor-specific data into simplified, high-level representations that are usable by software developers or software applications (e.g., games). Rather than exposing raw radar pulses or camera pixel streams, the API provides abstracted information such as object lists, classifications, positional indicators, or other semantic descriptors that are directly relevant to interactive applications. This abstraction enables software to be developed once and deployed across multiple vehicles.

On the developer or software application (e.g., game) side, the API includes a tool interface that allows software applications built using common development platforms or game engines to communicate with the vehicle through a consistent interface. The API maintains databases of supported vehicle platforms and supported development tools, enabling automatic configuration of communication details. As a result, developers or software applications remain insulated from vehicle system details and may work entirely within familiar software toolchains.

The approaches provided herein also support controlled bidirectional interaction. While some data (and in some cases, most data) flows from the vehicle to the software application, the API permits software applications to transmit control instructions—subject to safety and authorization constraints—to actuate physical vehicle components such as displays, audio systems, lighting, or other non-safety-critical devices. This enables interactive experiences that physically affect the vehicle environment and reinforces the real-world nature of the system.

Security and safety are incorporated into the architecture of the present approaches. Advantageously, the API functions as a firewall between the vehicle and external software, enforcing cybersecurity and functional-safety requirements. Different data sources and outputs may be assigned different security levels, ensuring that sensitive raw sensor data remains protected while still allowing abstracted information to be used for applications such as gaming and experiences.

The API further enables advanced interaction models, including question-answering and conversational exchanges between a software application and the vehicle. In these models, an application may ask semantic questions such as whether a pedestrian, object, or landmark is present, and the API responds using processed sensor data and, where applicable, human input obtained through in-vehicle interfaces. This supports interactive gameplay and human-in-the-loop experiences.

Additionally, the system supports recorded and simulated data, allowing software applications to operate on previously captured sensor information or on digital twin representations of the vehicle and its environment. This capability enables offline development, testing, replay scenarios, and virtualized experiences without requiring real-time vehicle operation.

The approaches described herein thus provide a scalable platform for next-generation in-car entertainment and experiences, enabling games and interactive software to leverage vehicle sensors, displays, and controls in a safe, secure, and platform-independent manner. By abstracting hardware complexity and standardizing vehicle interaction, the disclosed API opens the vehicle environment to a wide ecosystem of developers while preserving OEM control and safety guarantees.

The approaches disclosed herein are rooted in interaction with physical devices, physical sensors, and physical actuators operating in the real world. The disclosed API enables software applications, including computer games, to meaningfully interact with, receive data from, and cause controlled actuation of real vehicle hardware components.

In one example, a computer game consumes information provided through the API that originates from physical vehicle sensors, such as radar sensors, cameras, cabin monitoring sensors, steering sensors, occupancy sensors, GPS modules, or other vehicle-mounted sensing devices. The information provided to the game is not abstracted away entirely from the physical world, but instead represents measured conditions of the physical environment, such as the presence of pedestrians, vehicles, walls, buildings, landmarks, occupants, or other physical objects located inside or outside the vehicle.

This information may be used by the game for real-time computations, display generation, scoring, rule evaluation, randomness generation, or game progression, where the outcomes are directly tied to detected physical phenomena around the vehicle. For example, a game may award points when a physical object is detected, when a detected object changes position, or when occupants perform physical gestures detected by in-cabin sensors.

In further examples, the game may also directly or indirectly control physical vehicle devices through the API, subject to vehicle safety rules and authorization constraints. Such physical devices may include, for example, vehicle doors, locks, interior or exterior lighting, displays, speakers, haptic feedback devices, seat actuators, or window projections.

By way of illustration, a computer game such as a “musical chairs” style game may be executed while the vehicle is stationary. During gameplay, the game logic may instruct the API to lock or unlock vehicle doors, activate interior lighting patterns, or display visual cues on a vehicle screen as part of the game mechanics. These actions result in physical changes to the vehicle environment, reinforcing that the disclosed techniques are tightly coupled to physical systems.

In still other examples, the game communicates with the API to cause the API to issue control commands over the vehicle bus, thereby actuating vehicle components in ways that are responsive to game state, user actions, or detected conditions in the surrounding physical environment. Accordingly, the disclosed systems provide tangible, real-world interactions that go well beyond abstract data processing.

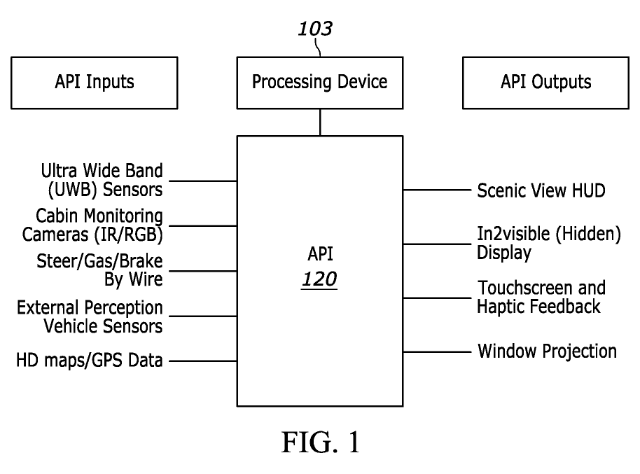

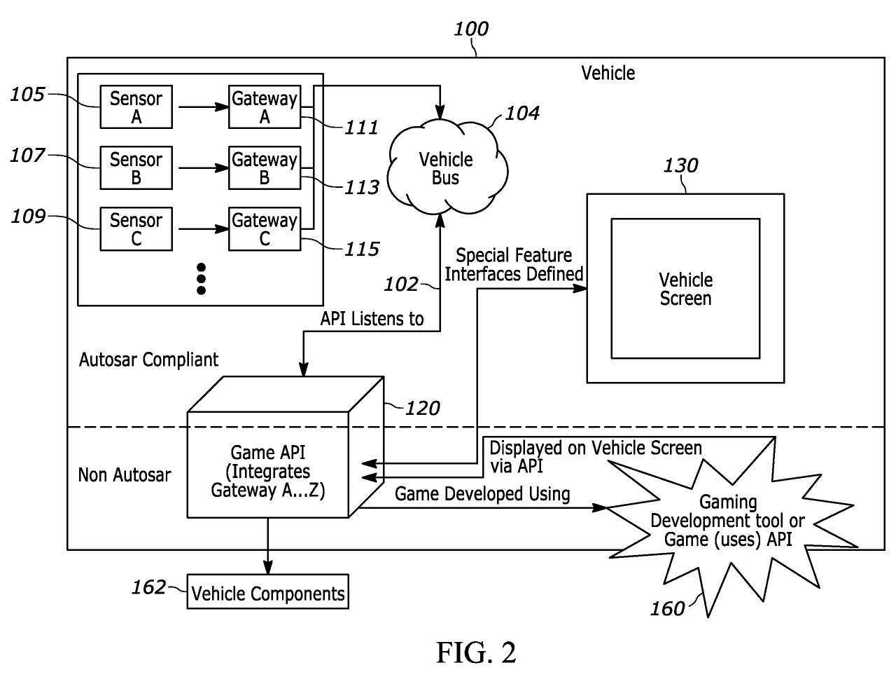

FIG. 1 illustrates an application programming interface (API) 120 executed by a processing device 103 where both of these structures are disposed in a vehicle and are used (as shown, for example, in FIG. 2) by experience and gaming software developers to develop games, or used by the games themselves. More specifically, developers (or software applications such as electronic games) may utilize vehicle data, including vehicle sensor data from in-cabin cameras, steering data from a sensor associated with the vehicle steering wheel or a steerable front wheel, perception data from the vehicle’s sensors which capture an environment of the vehicle, high definition maps or GPS data, etc. In addition, experience and gaming developers may develop software (e.g., games) which controls one or more actuators or other devices of a vehicle, such as a head-up display (HUD), window projection or other in-cabin display. Other examples are possible.

Sensor data interfaces often become hyper-specific to a vehicle platform once integrated to the vehicle’s communications bus. This means that any device configured to consume that data from the bus must also consume the platform-specific interface. The API according to the present disclosure is directed to a method for de-wrapping the vehicle sensor data once the data has passed through the vehicle bus to be made available to experience developers and gaming developers. Such developers are thus enabled to create based on a high-level interface without needing to conform to the vehicle-specific interface. This also enables these experiences to be portable across any platform supported by the high-level interface which is capable of expansion as more vehicle platforms opt-in and are added to the interface. This will drastically expand the user experience options for vehicles within a customer's fleet, or across fleets for a more unified end-customer experience.

In one or more implementations, the API 120 has a list of vehicle interfaces and platform-specific languages with which the API can interface. In a vehicle, the API 120 listens for signals on a vehicle bus to dynamically set "enabled" flags in the API 120 for any data signals it can hear, making such signals available to end user developers. For example, the signals are also simplified from "VehicleXYZ_Radar" or "VehicleABC_Radar" with customized data fields to a generic "Radar" with simplified data fields that better suit experience and/or gaming designers.

The API 120 can subscribe to services as well as offer subscriptions to the vehicle owner in service-based vehicle architectures. Additionally, signal-based communication types are also supported as an input or output. The API 120 functions as an abstraction layer between the service-based or signal-based vehicle architecture. Towards the vehicle, the API 120 is compatible to Autosar standards. The API 120 includes interface and integration documentation according to the Autosar standard, e.g., ARXML and manifest files. This allows an easy integration of the API 120 by the vehicle manufacturer or Tier 1 supplier as vehicle manufacturer/supplier can stay in the well-defined Autosar standards, toolchain and development processes. Game developers will stay on the non-Autosar side of the API 120.

The API 120 ensures with the abstraction of the automotive-specific Autosar interface, that cyber security and functional safety requirements for the vehicle 100 are not violated. Therefore, the API also serves as a firewall between the vehicle and the gaming development tools.

In an example embodiment, the API 120 contains logic and algorithms to synchronize the data streams to a global time master in the vehicle 100 (as shown in FIG. 2), by using the Autosar variant of gPTP timesync.

In addition to the simple routing and translation of the signals and services from the vehicle, the API 120 contains algorithms that abstract sensors, actuators and HMIs such as displays. These algorithms transform the specific output of modules in the vehicle into a generic (or “simplified”) data format and structures, e.g., creating a generic object list from a camera or radar sensor, providing a standard 1080p video output, or providing 16bit 44kHz stereo audio output. These algorithms include but are not limited to object tracking, computer vision, pattern recognition, machine learning, object classification, image signal processing, audio signal processing, image stitching, vehicle yaw rate calculation and offset compensation, and/or vehicle speed estimation. The algorithms may be, or may be based on, existing algorithms used in vehicles to perform various tasks.

The API 120 also is provided in versions that allow its integration into virtual vehicle simulation systems using established tools such as APG Carmaker.

The processing device 103 may itself include an electronic memory. In examples, the processing device 103 may be a separate diagnostics module or be included or incorporated with existing vehicle components such as at an engine control unit (ECU) or a telematics control unit (TCU). Other deployments are possible. The processing device 103 may be a general-purpose processor-type device that executes instructions retrieved from a memory (e.g., an electronic memory) and/or a specific purpose processing device (e.g., an application specific integrated circuit (ASIC) with integrated memory). The processing device 103 may be configured (for example, by using corresponding programming stored in a memory as will be well understood by those skilled in the art) to carry out one or more of the steps, actions, and/or functions described herein. The processing device 103 and/or any additional processing resources may run in parallel with one another such that multiple steps, actions, and/or functions are executed simultaneously. An electronic memory or other computer media at the processor may store electronic instructions that execute the various functions described herein. As shown in FIG. 1, the processing device 103 is at the vehicle (e.g., the processing device 103 may be or be associated with the ECU of the vehicle). However, it will also be appreciated that the processing device 103 can be located at other locations such as a central location such as the cloud or a central office or its functionality split amongst locations.

Computer instructions (or machine learning models) implementing the API 120 may be stored in a memory (not shown). This memory or any of the other memories or databases described herein may be or encompass volatile memory (e.g., Random Access Memory (RAM)) and non-volatile memory (such as Read-Only Memory (ROM) or flash memory). Other examples are possible.

FIG. 2 shows the API 120 associated with a vehicle 100. It will be appreciated that the processing device 103 may execute the API 120. The lines 102 connecting the interfaces (input/output) to the central cloud structure, which cloud structure corresponds to the vehicle bus 104, provide secure, encrypted translations from the vehicle-specific platform implementation back to the high-level interface of the API 120 that is easier to consume for software designers and more portable across many vehicle systems. Sensors A, B, and C (105, 107, and 109) may each have a specific gateway A, B, and C (111, 113, and 115), respectively, where the gateways are for directing and/or placing sensed data onto the vehicle bus 104. The gateways 111, 113, and 115 translate raw sensor data to a form that can be placed on the vehicle bus 104. API 120 may receive sensor data from any of sensors A-C (105, 107, and 109) via vehicle bus 104, and API 120 may place data onto the vehicle bus 104 in compliance with Autosar or other standardized software architecture framework utilized for communicating over the vehicle bus 104. API 120 may be also coupled to the vehicle screen 130 of the vehicle via the vehicle bus 104 or other connections. In this way, API 120 may provide the suitable control signals to control the vehicle screen 130 as directed by a software (gaming) development tool (or the software developed therefrom such as a game). Similarly, the API 120 may control vehicle components 162 (e.g., actuators, switches, engines, brakes) over the vehicle bus 104 in compliance with Autosar or other bus standard.

It is understood that the number of sensors which may provide sensor data on the vehicle bus 104 may vary and that three sensors A-C (105, 107, and 109) are used for illustrative purposes only. The sensors 105, 107, and 109 can be any type of sensor such as radar sensors, LiDAR sensors, motion sensors, cameras, temperature sensors, or magnetic sensors to mention a few examples.

In previous systems, each specific vehicle platform would need to expend significant effort to make such translations available to the software designer, or experiences need to be customized to the particular vehicle interface itself, drastically reducing portability to other vehicles.

Advantageously, the API 120, according to the example embodiments of the present disclosure, integrate multiple vehicle customization interfaces. The API 120 works across OEMs and vehicle platforms, providing standard interfaces from the perspective of the software development tools. In addition, the content provided by the API 120 is enriched with additional algorithms, such as computer vision and environment model algorithms. The API 120 does not compromise the security of the vehicle bus 104 and allows OEMs to continue to utilize the specific interface language(s) even when allowing a full experience and/or game library to the development system via the API 120. As shown in FIG. 2, the API 120 is coupled to a software platform 160. The software platform 160 may be used in the development of games or other software applications and/or the execution of software applications that have already been developed.

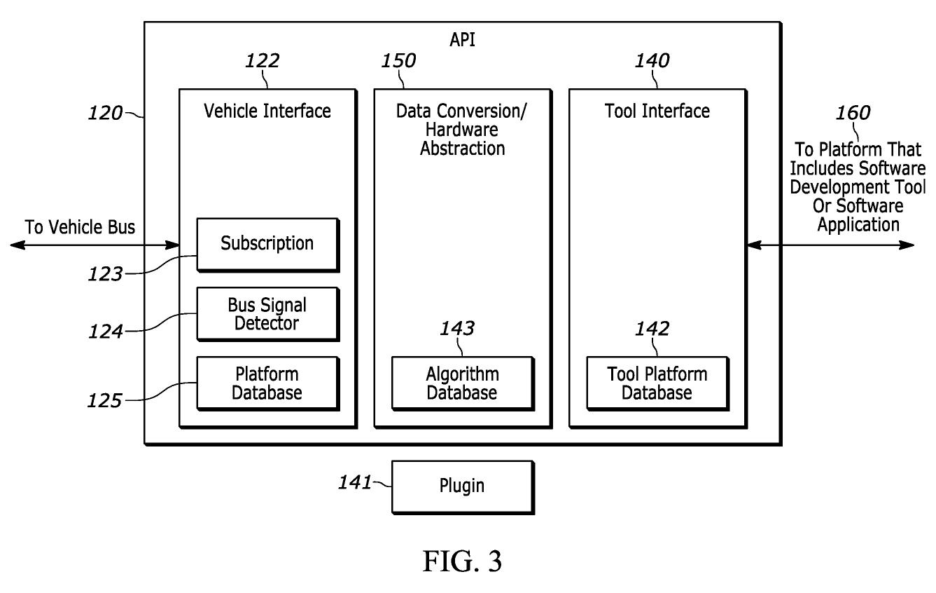

FIG. 3 illustrates in schematic form the API 120 according to an example embodiment. API 120 may be implemented in software, but it is understood that API 120 may be implemented in software and hardware which, upon executing the software’s instructions, configures the hardware to perform the API functions and operations discussed herein. The API 120 may also be implemented as one or more machine learning models. API 120 may include a vehicle interface 122 through which the API 120 communicates with the vehicle over the vehicle bus 104, compliant with Autosar or other appropriate standard. The vehicle interface 122 receives vehicle data placed on the vehicle bus 104 from, for example, sensors A-C (105, 107, 109). A subscription algorithm or module 123 is used to subscribe to services and offers subscriptions for in service-based vehicle architectures. A bus signal detector algorithm (or module) 124 detects signals appearing on or otherwise associated with the vehicle bus 104 and serves to monitor or otherwise “listen” to the bus and identify the data placed on the bus and the source thereof. For example, the bus signal detector 124 may detect data from a particular sensor A-C (105, 107, 109) which may then be obtained, processed and forwarded, or otherwise used to communicate data, to the development tool as described below. Vehicle interface 122 may further include a platform database 125 which maintains data for suitably communicating over the vehicle bus 104 in compliance with Autosar or other standard. The greater number of different vehicle platforms over which the vehicle interface 122 may communicate with the vehicle, the closer the API 120 is to being a universal, generic API. The vehicle interface 122 further includes a device control algorithm or module which provides (Autosar compliant) controls signals over the vehicle bus 104 to control an actuator or other device of the vehicle communicatively coupled to the vehicle bus.

The API 120 similarly includes a tool interface 140 which is configurable to communicate with any of a number of different software development tools, including gaming development tools, at the software platform 160. The tool interface 140 includes a developer tool database 142 having stored therein data allowing for the tool interface 140 to communicate and be configured for use with any of software development tool platform communicatively coupled to the API 120. For example, the tool interface 140 may be configurable for communication with Unity and Unreal Engine platforms. The communication to a coupled software development tool may include or be based on sensor data generated from a vehicle sensor A-C sent to the coupled software development tool or control data sent from the coupled software development tool for controlling a vehicle actuator or vehicle device, such as a vehicle display.

The API 120 further includes a data conversion hardware abstraction layer 150 which converts received vehicle data via the vehicle bus 104 to a simplified format that is relevant to experience/game developers. For example, instead of providing radar return data generated by a radar sensor and placed on the vehicle bus 104, the API 120 includes an algorithm database 143, a number of which may be executed using the radar return data to generate data corresponding to a person positioned relative to the vehicle, with the generated data of the person being sent to the developer tool over the tool interface 140 in a format corresponding to the coupled tool. In this way, the API 120 distills data generated in the vehicle and provides the distilled data to the coupled software platform 160 (e.g., that is using a software development tool or is executing a game) in the appropriate format. The API 120 may be configured in part by the coupled development tool to monitor signal data at the vehicle bus 104 for the data that is available and using the available algorithm database 143, data may be provided to the coupled development tool. The data may correspond to tracking a person or object outside the vehicle, tracking a vehicle occupant’s face inside the vehicle, etc. The API 120 may also be configured to project image data on a vehicle display surface. The tool interface 140 interfaces with the software platform 106 (e.g., a controller corresponding to or hosting a coupled developer tool) so the developer has functions available that are associated with the algorithms in the algorithm database 143.

In some aspects, the API 120 provides an abstraction between the Autosar standard environment of the vehicle. The API 120 may be configured for a service-based architecture or signal-based architecture.

It is envisioned that most data passes from the vehicle 100 to the software platform 160 (for use by a development tool or software application such as a game) coupled to the tool interface 140 of the API 120. However, as mentioned above, the API 120 also allows for control, at times that do not conflict with normal vehicle operation, actuators and displays of the vehicle. This involves data passes in the direction from the coupled development tool to the vehicle. Such passing data requires translation to the Autosar world by the API 120. This enables the gaming or experience developer to stay in his/her tool landscape and architecture.

With the capability to connect to and communicate over any vehicle bus, with a database of algorithms available to generate data based on data obtained from the vehicle bus 104, and with the capability to communicate with development tools (using the tool platform database) utilizing any of a number of platforms, the API 120 is, in at least some example embodiments, largely hardware agnostic. For example, a development tool may use acceleration sensor information from a vehicle for a game. The game may only be interested in the fact that the vehicle is accelerating and is not interested in the actual acceleration data from the vehicle IMU. API 120 includes the algorithms to distill the vehicle acceleration data on the vehicle bus 104 using the algorithms in the algorithm database 143 so that simplified acceleration information is provided to the developer tool. Using in the API 120 existing algorithms that are used in vehicles makes the system hardware agnostic for the software developer. This advantageously allows for software to be developed one time for use in many vehicles without customization for a particular vehicle or vehicle platform.

The API 120 thus allows for decoupling of gaming development and game execution from the vehicle design and/or vehicle system development so that the gaming and experience software may exist in a virtual environment and have connections to standard virtualization tools and simulation tools that simulate parts of a vehicle like capabilities of, for example, APG Carmaker.

The software development tool hosted at the software platform 160 may be wholly independent from the development of the vehicle and the vehicle architecture. This means that development teams are independent from each other. Games can be used on older vehicles without requiring redesign of any of the vehicle SW or vehicle bus system. In addition, games can be developed and tested virtually without knowledge about the vehicle design/architecture. This also gives the advantage that new games can be developed in parallel without having to disclose vehicle design specifics launched at the same time.

Advantageously, there is no additional cost for hardware because the existing components in the vehicle are made available.

In some implementations, the API 120 may include or be associated with a plug-in 141 for additional features and capabilities, for example, using the plug-in 141.

The API 120 may be implemented in software, hardware, firmware or any combination of software, hardware and firmware. Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. The API can also be implemented as a trained neural network or other type of machine learning model.

These computer programs (also known as programs, software, software applications or code) include machine instructions for a programmable processor, and can be implemented in a high-level procedural and/or object-oriented programming language, model-based design with auto-code generation, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In some embodiments, the API 120 is configured to respond to an information request from a game with proposed alternative data sources or representations when a requested data type is unavailable, restricted, or unsupported. For example, a game may request image data representing a nearby vehicle to display a visual element within the game. If a vehicle camera is unavailable, restricted for security reasons, or disabled in a particular operating mode, the API may respond by indicating that the requested image cannot be supplied and may propose an alternative, such as radar-based object data or symbolic object descriptors.

The game may then dynamically accept or reject the proposed alternative. If accepted, the API 120 supplies the alternative data, allowing gameplay to continue using a reduced or substitute feature set. The game may also dynamically enable or disable specific modes, visuals, or mechanics based on the negotiated data availability. This negotiation capability allows adaptive gameplay across different vehicles, configurations, and permissions.

In other aspects, the API implements variable security and confidentiality levels for data supplied to games and other external software. For example, raw radar data, raw camera imagery, or other sensitive sensor outputs may be assigned a higher confidentiality level and certain details are denied to games entirely. Instead, only processed, abstracted, or anonymized outputs generated by the data conversion hardware abstraction layer 150 are made available.

The security level may vary based on one or more factors, including the type of data, the source sensor, the identity or certification level of the game, the game version, vehicle state (e.g., moving vs. stationary), or user permissions. In this way, the API functions as a security-aware mediation layer that prevents unauthorized access to sensitive vehicle data while still enabling rich application functionality.

The API 120 may also support recorded or simulated vehicle data, allowing games to operate on non-real-time inputs. For example, radar readings, camera detections, or fused object lists may be recorded during real vehicle operation. These recorded datasets may later be provided to the game through the API 120 as if they were live sensor outputs.

This enables game testing, development, demonstration, replay modes, training scenarios, or offline gameplay without requiring an active vehicle environment. The data may be pre-processed by the data conversion hardware abstraction layer 150 at record time or playback time.

In some embodiments, the API 120 provides access to a digital twin representing the vehicle, its sensors, and the surrounding environment. The digital twin may be implemented as a processing device (e.g., the processing device 103 or a device external to the vehicle) and provide synthetic or simulated sensor outputs. The digital twin may be offered as a standardized, “clean” data representation separate from any developer-created digital twin, and may be licensed or provided as a separate product or service.

The format and completeness of information provided from the digital twin can vary. In some cases, the API 120 may provide a complete environmental snapshot, while in others it may provide partial data segments or individual object descriptors. This allows flexibility in bandwidth usage, game design, and computational load.

The present approaches also provide software plug-ins, extensions, or modular subroutines (illustrated by the plug-in 141) to the API 120 that are developed by third-party developers or internal teams. Such plug-ins may add new data transformations, mappings, algorithms, or content generation capabilities to the API 120. The API 120 may dynamically enable or disable plug-ins as needed based on vehicle configuration, game requirements, or licensing. This extensibility allows the API to evolve without redesign and enables a developer ecosystem around the platform.

The API 120 may include added intelligence enabling it to respond to semantic questions from a game or other vehicle systems. For example, a game may ask, “Is there a pedestrian near the vehicle?” The API 120 may combine data from multiple sensors, apply processing through the data conversion hardware abstraction layer 150, and return a direct answer rather than raw data. Such questions may also originate from other vehicle subsystems or user interfaces, allowing the API 120 to function as a centralized contextual knowledge layer.

In some embodiments, the API 120 supports conversational interaction model in which the game and API 120 exchange messages over multiple turns.

The interaction may resemble a dialogue, with prompts, responses, clarifying questions, and follow-ups. Information exchanged in earlier messages may influence later responses. This enables new classes of games driven by conversation, inference, and incremental information exchange.

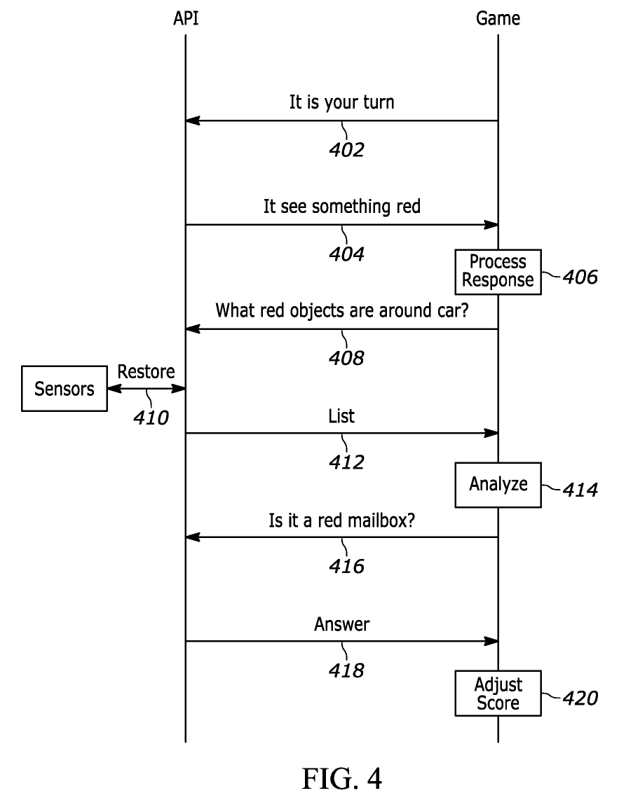

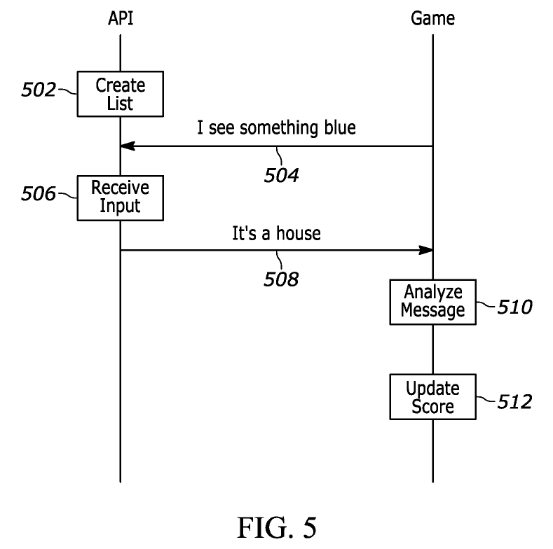

This interaction style is further illustrated in FIGS. 4 and 5, described below. FIGS. 4 and 5 illustrate two examples of the bidirectional interactions supported by the approaches provided herein and that other examples are possible. Referring specifically now to FIG. 4, at step 402, the game sends a conversational message to the API 120 indicating, for example, “It is your turn.” This message initiates a dialogue-based interaction rather than a one-time data request.

At step 404, the API 120 generates a response, which may be based on sensor data, processed results from the data conversion hardware abstraction layer 150, or human input obtained via vehicle interfaces. The API 120 returns, for example, “I see something red.”

At step 406, the game processes this response and at step 408 issues a follow-up question, such as “What red objects are around the car?”

At step 410, the API 120 retrieves relevant information from vehicle sensors, such as cameras, and processes that information through the data conversion hardware abstraction layer 150 to extract object-level descriptors. At step 412, the API 120 sends a list of candidate objects to the game, such as “red mailbox,” “red car,” or “red sign,” without providing raw image data.

At step 414, the game analyzes the list and, at step 416, asks a clarifying question, such as “Is it a red mailbox?”

At step 418, the API 120 returns an answer, which may be derived from sensor processing, user confirmation, or a combination of both.

At step 420, depending upon the answer, the game may update the score.

Referring now to FIG. 5, another example of API-game interaction is described. At step 502, the API 120 may create a list of objects under human direction. The list may include object attributes such as color, shape, category, or symbolic identifiers.

At step 504, the game communicates an observation such as “I see something blue,” which may be presented to occupants in the vehicle as part of the game.

At step 506, the API 120 receives human input, for example, “It is a house,” via voice input, touch input, or other interfaces and at step 508 sends this to the game.

At step 510, the game checks whether the identified object matches an entry in the list created earlier. If a match is confirmed, the game may update scoring, advance gameplay, or adjust game state accordingly at step 512.

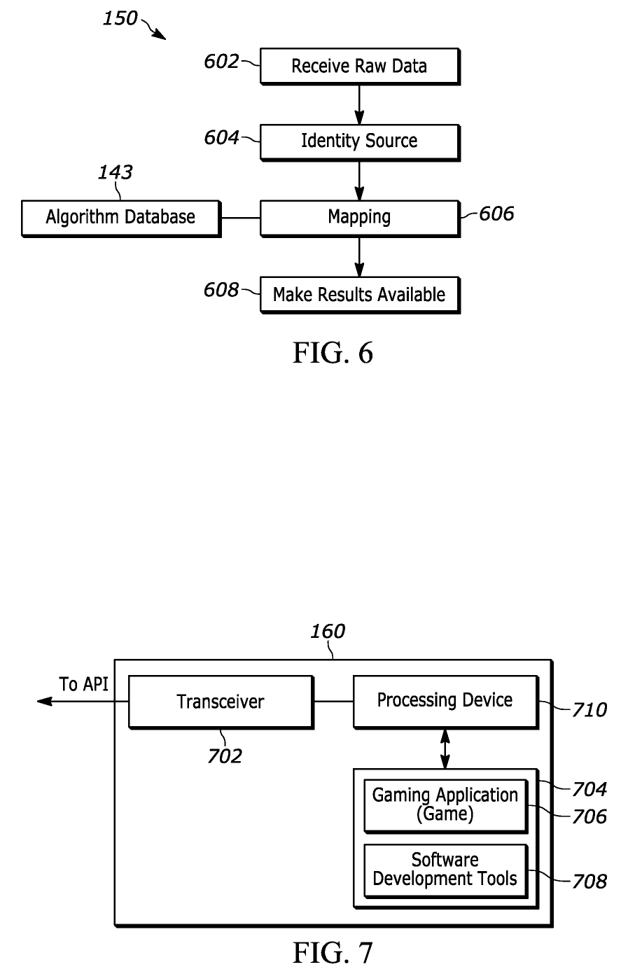

Referring now to FIG. 6, the structure and operation of the data conversion hardware abstraction layer 150, referred to as the data conversion and hardware abstraction layer, is described in greater detail. As described previously, the data conversion hardware abstraction layer 150 operates as a structured translation and mapping layer that receives vehicle data originating from physical sensors and vehicle subsystems and converts that data into simplified, semantically meaningful representations suitable for consumption by software applications such as games.

In one example embodiment, the API 120 provides a group of possible mapped outputs corresponding to available vehicle data sources. These mapped outputs may include, for example, indications such as “pedestrian detected,” “vehicle detected,” “wall present,” “object approaching,” “occupant present,” or similar high-level classifications. A developer of a game may select which of these mapped outputs the game requires. Other information may be provided and it will be appreciated that other examples are possible.

In some aspects, the groupings provided by the data conversion hardware abstraction layer 150 of the API 120 do not expose raw technical sensor details to the game. For example, while a radar sensor physically generates radar pulses and measures return times to infer distance and velocity, the game developer is not required to process or even access that raw radar waveform data. Instead, the data conversion hardware abstraction layer 150 maps the sensor-specific data into a record, object list, flag, or other structured dataset that conveys only the high-level condition relevant to gameplay.

For example, the data conversion hardware abstraction layer 150 may process radar data, camera data, or fused sensor data to determine that a “wall is present” or that a “person is present,” rather than providing millimeter-level distance measurements, raw pixel data, or radar return amplitudes. If a game needs to determine whether a wall is present, the game issues a request for that information, and the API—through the data conversion hardware abstraction layer 150—returns the mapped result.

In this manner, the data conversion hardware abstraction layer 150 maintains awareness of what information it can provide, rather than how that information is technically generated at the sensor level. The mapping performed by data conversion hardware abstraction layer 150 thus separates sensor physics and signal processing from application-level logic, enabling portability, safety, and security across vehicle platforms.

The data conversion hardware abstraction layer 150 may be implemented as a sequenced set of computer instructions performing various steps. At step 602, raw data is received from a vehicle bus.

At step 604, the data source is identified (if needed) and at step 606 mapping is made from the raw data to obtain a “simplified” or “generic” format using an algorithm from an algorithm database 143. In aspects, the algorithm database 143 includes at least one of an object tracking algorithm, a computer vision based algorithm, a pattern recognition algorithm, machine learning, an object classification algorithm, an image signal processing algorithm, and audio signal processing algorithm, an image stitching algorithm, a vehicle yaw rate calculator algorithm, or a vehicle speed estimation algorithm. Other examples are possible.

At step 608, the simplified result is offered or made available the software platform 160 (e.g., the game or a developer using a tool).

As used herein, a “simplified format” (or “simplified result”) refers to a data representation generated by the application programming interface (API) from vehicle-originated data, wherein the data representation is structurally reduced, semantically enriched, and/or implementation-agnostic relative to the original vehicle sensor or subsystem data. The simplified format may change the original type of information (e.g., detailed radar data) gathered by sensors to a reduced (and different) result (e.g., a wall is present) that has direct meaning to (or is directly usable by) a game.

The simplified format is produced by processing one or more signals obtained from a vehicle communications bus and transforming those signals using one or more algorithms such that vehicle-specific, sensor-specific, or platform-specific details are removed or abstracted, while retaining information sufficient for use by a software application.

In one embodiment, the simplified format excludes raw sensor outputs, including but not limited to radar waveforms, pulse timing data, pixel-level image data, raw audio samples, or bus-specific message structures. Instead, the Simplified format includes high-level data structures, such as records, objects, flags, lists, or descriptors, that convey interpretable conditions, classifications, or states relevant to application logic.

The simplified format may, by way of non-limiting examples, represent information such as: the presence or absence of one or more physical objects, a classification of an object (e.g., pedestrian, vehicle, wall, structure), a relative position, direction, or proximity indicator, a detected event or condition, or a semantic response to a query posed by a software application. Other examples are possible.

In some examples, the simplified format is independent of the specific sensor technology used to generate the underlying data. For example, an indication that a “wall is present” may be generated from radar data, camera data, sensor fusion outputs, or previously recorded data, without exposing the manner in which that determination was technically made. In aspect, the simplified format removes, reduces, or eliminates technology -specific details related to sensing systems or other vehicle system.

In some embodiments, the simplified format is selectable from a predefined set of supported output types maintained by the API 120. A software application may request one or more of these output types without knowledge of which sensors or algorithms are used to generate them. The API 120 determines whether requested simplified outputs are available and, if so, provides them in the simplified format.

In other aspects, the simplified format may further be constrained by security or confidentiality rules, such that sensitive information is omitted while still enabling application functionality. Different simplified formats may exist for different authorization levels, software applications, or operating conditions.

In aspects, the simplified format is structured to be directly consumable by software applications, including computer games, without requiring domain expertise in automotive sensor systems, vehicle bus protocols, or signal processing. Accordingly, the Simplified format enables development portability, platform independence, and safe interaction with physical vehicle systems.

Referring now to FIG. 7, one example of a software platform 160 include a software gaming application and software (gaming) development tools. The software platform 160 includes a transceiver 702, an electronic memory 704, and a processing device 710. The software platform 160 may be used by a developer to develop games. In these regards, a developer may interact with the software platform via an interface (not shown, but potentially including a touch screen, keypad, and other interaction elements). In addition, the platform 160 may be used to execute computer games. In aspects, the software platform may be incorporated in or be a smartphone, a lap top, or a personal computer to mention a few examples.

The transceiver 702 receives the converted data from the API. During development or game operation, transmits signals to the API as described elsewhere herein.

The electronic memory 704 stores software gaming application 706 and software development tools 708.

The processing device 710 (executes instructions) from the memory 704. The processing device 710 may itself include an electronic memory. The processing device 710 may be a general-purpose processor-type device that executes instructions retrieved from a memory (e.g., an electronic memory) and/or a specific purpose processing device (e.g., an application specific integrated circuit (ASIC) with integrated memory). The processing device 710 may be configured (for example, by using corresponding programming stored in a memory as will be well understood by those skilled in the art) to carry out one or more of the steps, actions, and/or functions described herein. The processing device 710 and/or any additional processing resources may run in parallel with one another such that multiple steps, actions, and/or functions are executed simultaneously. An electronic memory or other computer media at the processor may store electronic instructions that execute the various functions described herein.

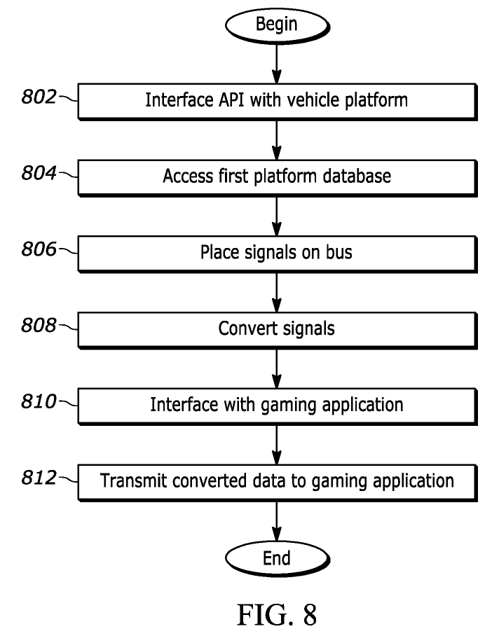

Referring now top FIG. 8, one example of the present approaches is described. At step 802, using a first interface, an API is interfaced with a vehicle platform having a vehicle communications bus in a vehicle.

At step 804, a first platform database containing first bus access information associated with a plurality of communications buses of the vehicle is accessed, and a first bus access information corresponding to the vehicle platform is selected.

At step 806 and at the first interface, signals placed onto a communications bus of the vehicle that is associated with the selected first bus access information are obtained. At step 808, the obtained signals are converted to create converted data.

At step 810 and through a second interface, interfacing with a software gaming application coupled to the second interface is accomplished. The interfacing is accomplished using second bus access information obtained from a second platform database.

At step 812, the converted data is transmitted over the second interface to the software gaming application using the selected second bus access information. The converted data is utilized by the software gaming application to control a component or system of the vehicle, or be utilized in the software gaming application in a game.

A number of implementations have been described. Nevertheless, it will be understood that various modifications may be made without departing from the spirit and scope of the disclosure. Accordingly, other implementations are within the scope of the following claims.

What is claimed is:

1. An interface method for use with a vehicle, the method comprising:
using a first interface, interfacing with a vehicle platform having a vehicle communications bus in a vehicle;
accessing a first platform database containing first bus access information associated with a plurality of communications buses of the vehicle, and selecting first bus access information corresponding to the vehicle platform;
obtaining, at the first interface, signals placed onto a communications bus of the vehicle that is associated with the selected first bus access information;
converting the obtained signals to create converted data;
though a second interface, interfacing with a software gaming application coupled to the second interface, the interfacing being accomplished using second bus access information obtained from a second platform database;
transmitting the converted data over the second interface to the software gaming application using the selected second bus access information;
wherein the converted data is utilized by the software gaming application to control a component or system of the vehicle, or utilized in the software gaming application in a game.

2. The method of claim 1, wherein converting the obtained signals comprises selecting a first algorithm from an algorithm database containing algorithms, such that the converted data is based upon the selected first algorithm and the obtained signals.

3. The method of claim 2, wherein the algorithm database includes at least one of an object tracking algorithm, a computer vision based algorithm, a pattern recognition algorithm, machine learning, an object classification algorithm, an image signal processing algorithm, and audio signal processing algorithm, an image stitching algorithm, a vehicle yaw rate calculator algorithm, or a vehicle speed estimation algorithm.

4. The method of claim 1, wherein transmitting the converted data comprises responding to a request from the software gaming application with at least one proposed alternative data representation when requested data is unavailable or restricted.

5. The method of claim 1, wherein converting the obtained signals comprises applying a security level that limits access to raw sensor data while permitting access to abstracted or processed data.

6. The method of claim 1, wherein the converted data originates from previously recorded vehicle sensor data rather than real-time sensor data.

7. The method of claim 1, wherein converting the obtained signals comprises generating data using a digital twin representing the vehicle and an environment surrounding the vehicle.

8. The method of claim 1, further comprising executing a plug-in associated to add or modify data conversion functionality available to the software application.

9. The method of claim 1, wherein converting the obtained signals comprises responding to semantic questions from the software gaming application.

10. The method of claim 1, wherein communication with the software gaming application comprises a multi-turn conversational interaction.

11. The method of claim 10, wherein at least one conversational response is influenced by prior exchanged messages within the interaction.

12. The method of claim 1, wherein a software developer uses the converted data to develop the software gaming application.

13. The method of claim 1, further comprising transmitting control signals from the software gaming application to actuate at least one physical vehicle component in response to gameplay logic.

14. An application programming interface (API) system for use with a vehicle, the API system comprising:
a first platform database storing first bus access information associated with a plurality of vehicle communications buses;
a second platform database storing second bus access information associated with a plurality of software platforms executing software gaming applications;
one or more processors coupled to the first platform database and the second platform database, the one or more processors having electronic instructions that when executed comprise an application programming interface (API), the instructions defining:
a first interface configured to (i) interface with a vehicle platform, (ii) obtain, from the first platform database, first bus access information corresponding to the vehicle platform, and (iii) obtain signals placed onto the vehicle communications bus using the first bus access information;
a data conversion hardware abstraction layer configured to convert the signals obtained from the vehicle communications bus via the first interface into converted data having a simplified format;
a second interface configured to (i) receive the converted data from the data conversion hardware abstraction layer, (ii) interface with a software gaming application being executed by a software platform using second bus access information obtained from the second platform database; and (iii) transmit the converted data to the software gaming application using the second bus access information;
wherein the converted data is utilized by the software gaming application to control a component or system of the vehicle, or utilized by the software gaming application in a game.

15. The API system of claim 14, wherein the one or more processors are configured to, in response to a request from the software gaming application for requested data that is unavailable or restricted, provide at least one proposed alternative data representation.

16. The API system of claim 14, wherein the one or more processors are configured to apply a security level that limits access to raw sensor data while permitting access to abstracted or processed data generated by the data conversion hardware abstraction layer.

17. The API system of claim 14 wherein the one or more processors are configured to provide the converted data originating from previously recorded vehicle sensor data rather than real-time sensor data.

18. The API system of claim 14, wherein the one or more processors are configured to generate data corresponding to a digital twin representing the vehicle and an environment surrounding the vehicle.

19. The API system of claim 14, wherein the one or more processors are configured to respond to semantic questions from the software gaming application.

20. The API system of claim 14, wherein the one or more processors are configured to support a multi-turn conversational interaction between the software gaming application and the API system via iterative messages exchanged over the second interface.
